(19) United States
(12) Patent Application Publication
(10) Pub. No.: US 2021/0362597 A1
(43) Pub. Date: Nov. 25, 2021

(54) VEHICLE CONTROL DEVICE AND VEHICLE INCLUDING THE SAME

(71) Applicant: LG Electronics Inc., Seoul (KR)

(72) Inventors: Sungil CHO, Seoul (KR); Jayoen KIM, Seoul (KR); Yujune JANG, Seoul (KR)

(73) Assignee: LG ELECTRONICS INC., Seoul (KR)

(21) Appl. No.: 16/490,473

(22) PCT Filed: Apr. 8, 2019
(86) PCT No.: PCT/KR2019/004147

§ 371 Date: Aug. 30, 2019

(30) Foreign Application Priority Data
Apr. 12, 2018 (KR) 10-2018-0042517

(51) Int. Cl. B60K 35/00; B60W 40/08; G06F 3/01; G06F 3/0488

(52) U.S. Cl. CPC B60K 35/00; B60W 40/08; G06F 3/013; G06F 3/0488; B60K 2370/1438; B60W 2540/225; B60K 2370/176; B60K 2370/194; B60K 2370/195; B60K 2370/785; B60K 2370/149

(57) ABSTRACT

The present invention relates to a vehicle control device for controlling a vehicle with a windshield. The vehicle control device includes: an image output unit that outputs visual information to the windshield; and a processor that sets a portion of the windshield as an image output area and controls the image output unit to display visual information in the image display area, wherein the processor detects one or more objects overlapping the image output area based on the passenger's gaze, among objects located outside the vehicle, and controls the image output unit to display guidance information on a detected object in the image output area.

### TECHNICAL FIELD

The present invention relates to a vehicle control device that controls a vehicle and a vehicle including the same.

### BACKGROUND ART

A vehicle denotes a means of transporting people or goods using kinetic energy. Representative examples of vehicles include automobiles and motorcycles.

For safety and convenience of a user who uses the vehicle, various sensors and devices are provided in the vehicle, and the functions of the vehicle are diversified.

The function of the vehicle may be divided into a convenience function for promoting the convenience of a driver and a safety function for promoting the safety of a driver and/or a pedestrian.

First, the convenience function has a motive for development related to driver convenience, such as giving an infotainment (information+entertainment) function to the vehicle, supporting a partial autonomous driving function, or assisting the driver's vision such as night vision or blind spot. For example, the convenience function may include an active cruise control (ACC) function, a smart parking assist system (SPAS) function, a night vision (NV) function, a head up display (HUD) function, an around view monitor (AVM) function, and an adaptive headlight system (AHS) function, and the like.

The safety function is a technology for securing the safety of the driver and/or the safety of a pedestrian, and may include a lane departure warning system (LDWS) function, a lane keeping assist system (LKAS) function, an autonomous emergency braking (AEB) function, and the like.

For convenience of a user using a vehicle, various types of sensors and electronic devices are provided in the vehicle. In particular, for the convenience of the user's driving, research on an advanced driver assistance system (ADAS) is being actively carried out. Furthermore, development of an autonomous vehicle is being actively carried out.

In recent years, as the development of an advanced driving assist system (ADAS) is actively undergoing, development of a technology for optimizing user's convenience and safety while driving a vehicle is required.

As part of this, there arises the need for the technological development of various UIs/UXs (user interfaces/user experiences) using a windshield of a vehicle.

### DISCLOSURE

### Technical Problem

Therefore, an object of the present invention is to provide a vehicle control device capable of outputting various information on a windshield of a vehicle and a method for controlling the vehicle.

### Technical Solution

The present invention relates to a vehicle control device mounted to a vehicle with a windshield.

The vehicle control device may include: an image output unit that outputs visual information to the windshield; and a processor that sets a portion of the windshield as an image output area and controls the image output unit to display visual information in the image display area, wherein the processor may detect one or more objects overlapping the image output area based on the passenger's gaze, among objects located outside the vehicle, and controls the image output unit to display guidance information on a detected object in the image output area.

According to an embodiment, the processor may output the guidance information in response to a preset touch input applied to the windshield.

According to an embodiment, the processor may control the image output unit to display an image captured a first base time before the touch input is applied, in the image output area.

According to an embodiment, the first base time may vary with the speed of the vehicle.

According to an embodiment, the processor may merge a plurality of frames captured within a predetermined time span into a single still image and controls the image output unit to display the still image in the image output area.

According to an embodiment, the processor may extract at least a portion of each frame corresponding to the image output area and merge extracted portions into the still image.

According to an embodiment, the processor changes the predetermined time span based on a user input applied to the image output area where the still image is being outputted, and the still image displayed in the image display area may be changed with the change in time span.

According to an embodiment, the vehicle control device may further include a communication unit that receives the image from a camera equipped in the vehicle.

According to an embodiment, the vehicle control device may further include a memory that stores an image received from the camera, wherein the processor may delete at least one between an image captured a second base time before and an image stored in the memory the second base time before, and the second base time is longer than the first base time.

According to an embodiment, the image may be updated as the vehicle moves.

According to an embodiment, the processor may detect an object of the passenger's interest from the image and control the image output unit to display object-of-interest guidance information for giving guidance on the object of interest.

According to an embodiment, the object-of-interest guidance information may vary with the passenger.

According to an embodiment, the processor may set the image output area with respect to the position of the touch input.

According to an embodiment, if the touch input is re-applied to the image output area while the guidance information is being outputted to the image output area, the processor may control the image output unit to make the guidance information disappear.

According to an embodiment, the processor may detect one or more objects overlapping the passenger's gaze and the position of the touch input, among objects located outside the vehicle.

According to an embodiment, the processor may re-detect one or more objects as the vehicle moves and update the guidance information to give guidance on the re-detected object(s).

According to an embodiment, at least one between the size and position of the image output area may vary with the passenger.

According to an embodiment, at least one between the size and position of the image output area may vary with the location of the vehicle.

According to an embodiment, at least one between the size and position of the image output area may vary with the passenger's seat position.

According to an embodiment, at least one between the size and position of the image output area may vary with the speed of the vehicle.

Moreover, the present invention may be extensively applied to a vehicle with the above-described vehicle control device and/or a vehicle control method.

### Advantageous Effects

Embodiments of the present invention provide one or more advantages as follows.

It is difficult for a passenger in a vehicle to identify a fast passing-by object within a short time while the vehicle is travelling. According to the present invention, an augmented reality user interface may be provided by providing guidance information on objects outside the vehicle through a windshield. An object a passenger wants to identify can be accurately pinpointed because the object is detected based on the passenger's gaze.

### BRIEF DESCRIPTION OF THE DRAWINGS

FIG. 1 is a view illustrating an appearance of a vehicle according to an embodiment of the present disclosure.

FIG. 2 is a view in which a vehicle according to an embodiment of the present disclosure is viewed at various angles from the outside.

FIGS. 3 and 4 are views illustrating an inside of a vehicle according to an embodiment of the present disclosure.

FIGS. 5 and 6 are views referenced to describe objects according to an embodiment of the present disclosure.

FIG. 7 is a block diagram referenced to describe a vehicle according to an embodiment of the present disclosure.

FIG. 8 is a conceptual view for explaining a vehicle control device according to an embodiment of the present disclosure.

FIG. 9 is a flowchart for explaining a representative control method of the present disclosure.

FIGS. 10A and 10B are illustrations of the control method of FIG. 9.

FIG. 11 is a flowchart for explaining a method of outputting guidance information via a preset touch input.

FIGS. 12A, 12B, and 12C are illustrations of the method of FIG. 11.

FIG. 13 is a flowchart for explaining a method of outputting guidance information by using a camera-captured image.

FIG. 14 is a conceptual diagram for explaining the method of FIG. 13.

FIG. 15 is a flowchart for explaining a method of merging a plurality of frames to output guidance information.

FIGS. 16A and 16B are conceptual diagrams for explaining the method of FIG. 15.

FIG. 17 is an illustration of an operation of a vehicle control device according to the present invention.

### MODES FOR CARRYING OUT THE PREFERRED EMBODIMENTS

Hereinafter, the embodiments disclosed herein will be described in detail with reference to the accompanying drawings, and the same or similar elements are designated with the same numeral references regardless of the numerals in the drawings and their redundant description will be omitted. A suffix “module” and “unit” used for constituent elements disclosed in the following description is merely intended for easy description of the specification, and the suffix itself does not give any special meaning or function. In describing the embodiments disclosed herein, moreover, the detailed description will be omitted when specific description for publicly known technologies to which the invention pertains is judged to obscure the gist of the present invention. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle according to an embodiment of the present disclosure may be understood as a conception including cars, motorcycles and the like. Hereinafter, the vehicle will be described based on a car.

The vehicle according to the embodiment of the present disclosure may be a conception including all of an internal combustion engine car having an engine as a power source, a hybrid vehicle having an engine and an electric motor as power sources, an electric vehicle having an electric motor as a power source, and the like.

In the following description, a left side of a vehicle refers to a left side in a driving direction of the vehicle, and a right side of the vehicle refers to a right side in the driving direction.

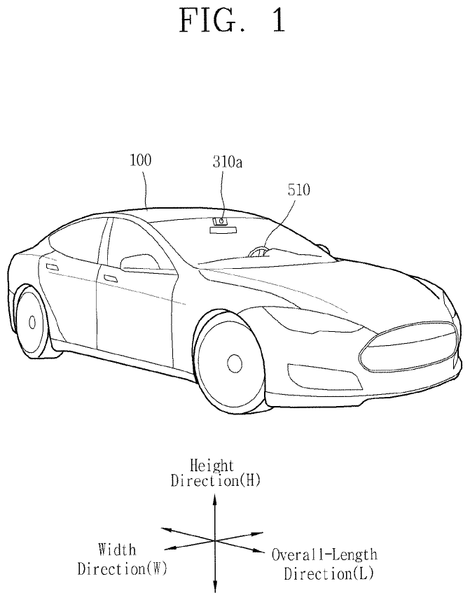

FIG. 1 is a view illustrating an appearance of a vehicle according to an embodiment of the present disclosure.

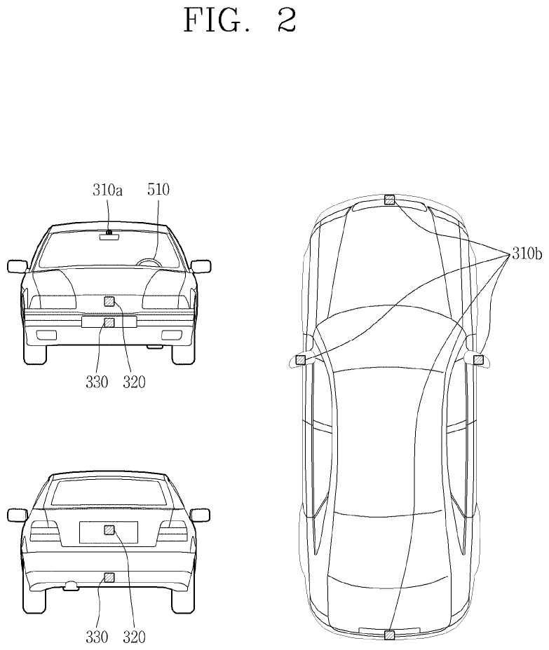

FIG. 2 is a view in which a vehicle according to an embodiment of the present disclosure is viewed at various angles from the outside.

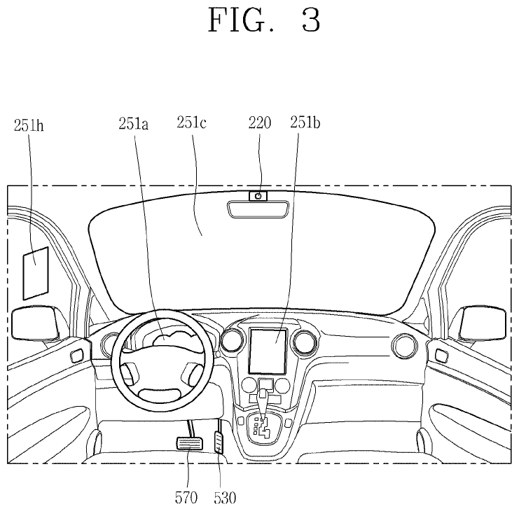

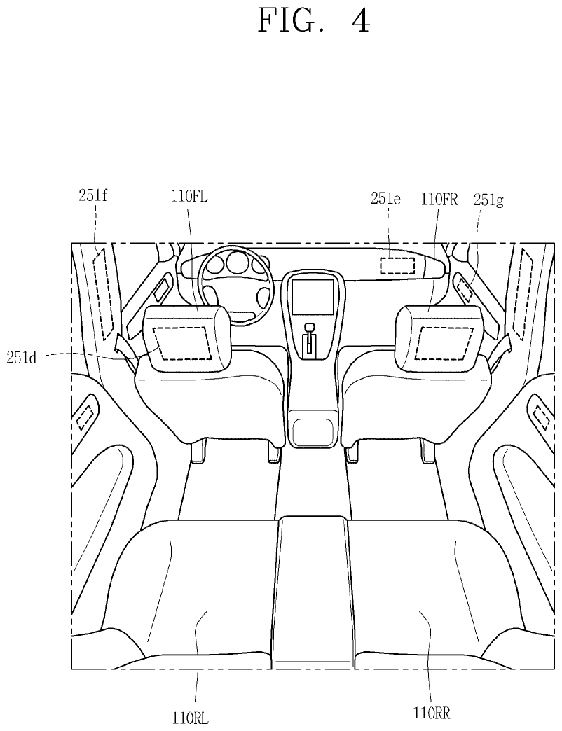

FIGS. 3 and 4 are views illustrating an inside of a vehicle according to an embodiment of the present disclosure.

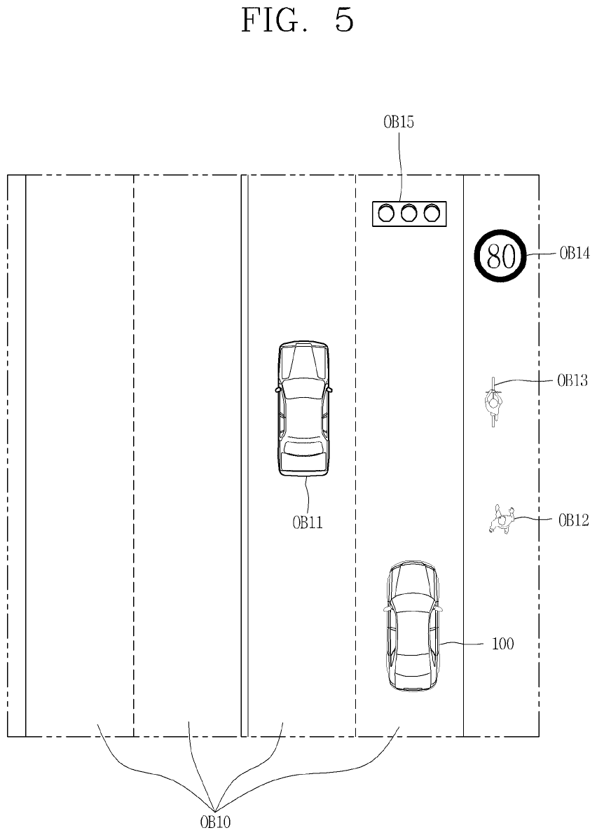

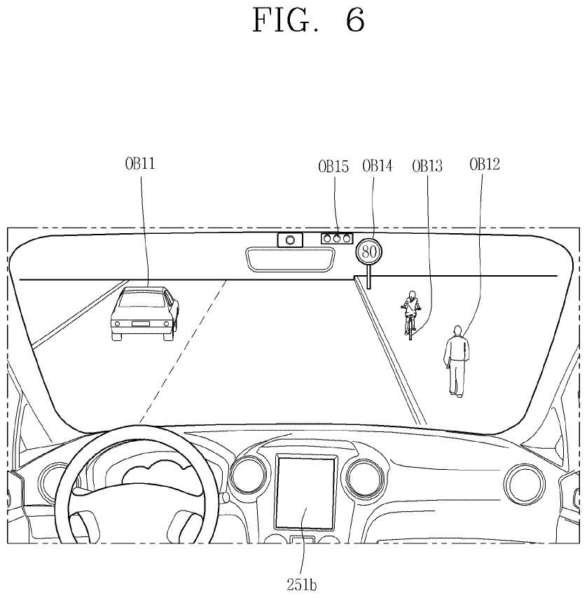

FIGS. 5 and 6 are views referenced to describe objects according to an embodiment of the present disclosure.

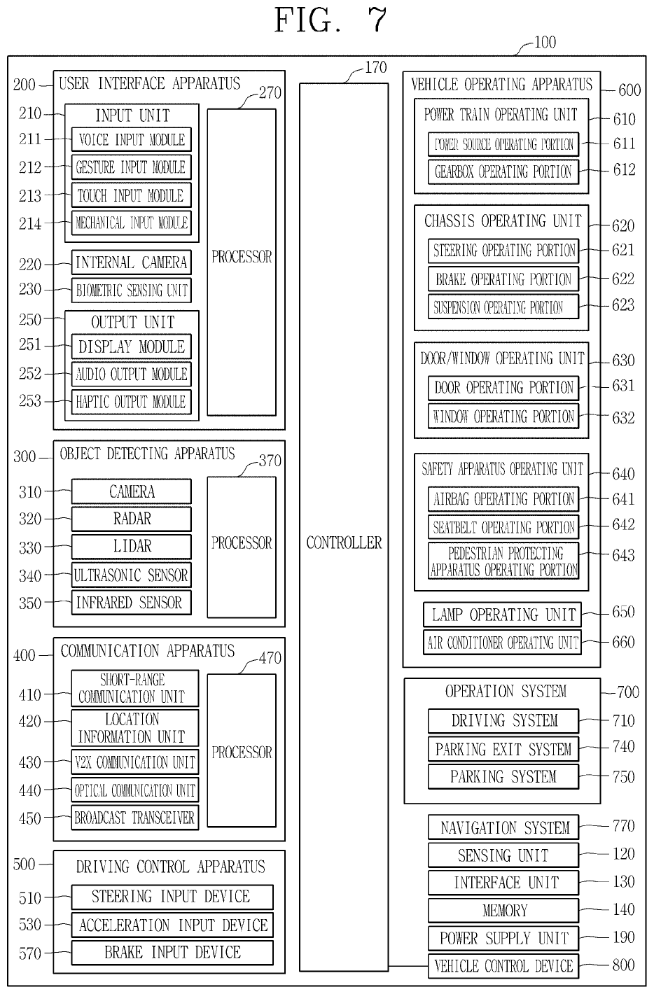

FIG. 7 is a block diagram referenced to describe a vehicle according to an embodiment of the present disclosure.

Referring to FIGS. 1 through 7, a vehicle 100 may include wheels turning by a driving force, and a steering apparatus 510 for adjusting a driving (ongoing, moving) direction of the vehicle 100.

The vehicle 100 may be an autonomous vehicle.

Here, autonomous driving is defined as controlling at least one of acceleration, deceleration, and driving direction based on a predetermined algorithm. In other words, it denotes that a driving operation device is automatically operated even if no user input is entered to the driving operation device.

The vehicle 100 may be switched into an autonomous mode or a manual mode based on a user input.

For example, the vehicle may be converted from the manual mode into the autonomous mode or from the autonomous mode into the manual mode based on a user input received through a user interface apparatus 200.

The vehicle 100 may be switched into the autonomous mode or the manual mode based on driving environment information. The driving environment information may be generated based on object information provided from an object detecting apparatus 300.

For example, the vehicle 100 may be switched from the manual mode into the autonomous mode or from the autonomous module into the manual mode based on driving environment information generated in the object detecting apparatus 300.

In an example, the vehicle 100 may be switched from the manual mode into the autonomous mode or from the autonomous module into the manual mode based on driving environment information received through a communication apparatus 400.

The vehicle 100 may be switched from the manual mode into the autonomous mode or from the autonomous module into the manual mode based on information, data or signal provided from an external device.

When the vehicle 100 is driven in the autonomous mode, the autonomous vehicle 100 may be driven based on an operation system 700.

For example, the autonomous vehicle 100 may be driven based on information, data or signal generated in a driving system 710, a parking exit system 740 and a parking system 750.

When the vehicle 100 is driven in the manual mode, the autonomous vehicle 100 may receive a user input for driving through a driving control apparatus 500. The vehicle 100 may be driven based on the user input received through the driving control apparatus 500.

An overall length refers to a length from a front end to a rear end of the vehicle 100, a width refers to a width of the vehicle 100, and a height refers to a length from a bottom of a wheel to a roof. In the following description, an overall-length direction L may refer to a direction which is a criterion for measuring the overall length of the vehicle 100, a width direction W may refer to a direction that is a criterion for measuring a width of the vehicle 100, and a height direction H may refer to a direction that is a criterion for measuring a height of the vehicle 100.

As illustrated in FIG. 7, the vehicle 100 may include a user interface apparatus 200, an object detecting apparatus 300, a communication apparatus 400, a driving control apparatus 500, a vehicle operating apparatus 600, an operation system 700, a navigation system 770, a sensing unit 120, an interface unit 130, a memory 140, a controller 170 and a power supply unit 190.

According to embodiments, the vehicle 100 may include more components in addition to components to be explained in this specification or may not include some of those components to be explained in this specification.

The user interface apparatus 200 is an apparatus for communication between the vehicle 100 and a user. The user interface apparatus 200 may receive a user input and provide information generated in the vehicle 100 to the user. The vehicle 200 may implement user interfaces (UIs) or user experiences (UXs) through the user interface apparatus 200.

The user interface apparatus 200 may include an input unit 210, an internal camera 220, a biometric sensing unit 230, an output unit 250 and a processor 270.

According to embodiments, the user interface apparatus 200 may include more components in addition to components to be explained in this specification or may not include some of those components to be explained in this specification.

The input unit 200 may allow the user to input information. Data collected in the input unit 200 may be analyzed by the processor 270 and processed as a user's control command.

The input unit 210 may be disposed within the vehicle. For example, the input unit 200 may be disposed on one area of a steering wheel, one area of an instrument panel, one area of a seat, one area of each pillar, one area of a door, one area of a center console, one area of a headlining, one area of a sun visor, one area of a wind shield, one area of a window or the like.

The input unit 210 may include a voice input module 211, a gesture input module 212, a touch input module 213, and a mechanical input module 214.

The audio input module 211 may convert a user's voice input into an electric signal. The converted electric signal may be provided to the processor 270 or the controller 170.

The voice input module 211 may include at least one microphone.

The gesture input module 212 may convert a user's gesture input into an electric signal. The converted electric signal may be provided to the processor 270 or the controller 170.

The gesture input module 212 may include at least one of an infrared sensor and an image sensor for detecting the user's gesture input.

According to embodiments, the gesture input module 212 may detect a user's three-dimensional (3D) gesture input. To this end, the gesture input module 212 may include a light emitting diode outputting a plurality of infrared rays or a plurality of image sensors.

The gesture input module 212 may detect the user's 3D gesture input by a time of flight (TOF) method, a structured light method or a disparity method.

The touch input module 213 may convert the user's touch input into an electric signal. The converted electric signal may be provided to the processor 270 or the controller 170.

The touch input module 213 may include a touch sensor for detecting the user's touch input.

According to an embodiment, the touch input module 213 may be integrated with the display unit 251 so as to implement a touch screen. The touch screen may provide an input interface and an output interface between the vehicle 100 and the user.

The mechanical input module 214 may include at least one of a button, a dome switch, a jog wheel, and a jog switch. An electric signal generated by the mechanical input module 214 may be provided to the processor 270 or the controller 170.

The mechanical input module 214 may be arranged on a steering wheel, a center fascia, a center console, a cockpit module, a door and the like.

The internal camera 220 may acquire an internal image of the vehicle. The processor 270 may detect a user's state based on the internal image of the vehicle. The processor 270 may acquire information related to the user's gaze from the internal image of the vehicle. The processor 270 may detect a user gesture from the internal image of the vehicle.

The biometric sensing unit 230 may acquire the user's biometric information. The biometric sensing module 230 may include a sensor for detecting the user's biometric information and acquire fingerprint information and heart rate information regarding the user using the sensor. The biometric information may be used for user authentication.

The output unit 250 may generate an output related to a visual, audible or tactile signal.

The output unit 250 may include at least one of a display module 251, an audio output module 252 and a haptic output module 253.

The display module 251 may output graphic objects corresponding to various types of information.

The display module 251 may include at least one of a liquid crystal display (LCD), a thin film transistor-LCD (TFT LCD), an organic light-emitting diode (OLED), a flexible display, a three-dimensional (3D) display and an e-ink display.

The display module 251 may be inter-layered or integrated with a touch input module 213 to implement a touch screen.

The display module 251 may be implemented as a head up display (HUD). When the display module 251 is implemented as the HUD, the display module 251 may be provided with a projecting module so as to output information through an image which is projected on a windshield or a window.

The display module 251 may include a transparent display. The transparent display may be attached to the windshield or the window.

The transparent display may have a predetermined degree of transparency and output a predetermined screen thereon. The transparent display may include at least one of a transparent TFEL (Thin Film Electroluminescent), a transparent OLED (Organic Light-Emitting Diode), a transparent LCD (Liquid Crystal Display), a transmissive transparent display, and a transparent LED (Light Emitting Diode) display. The transparent display may have adjustable transparency.

Meanwhile, the user interface apparatus 200 may include a plurality of display modules 251a to 251g.

The display module 251 may be disposed on one area of a steering wheel, one area 521a, 251b, 251e of an instrument panel, one area 251d of a seat, one area 251f of each pillar, one area 251g of a door, one area of a center console, one area of a headlining or one area of a sun visor, or implemented on one area 251c of a windshield or one area 251h of a window.

The audio output module 252 converts an electric signal provided from the processor 270 or the controller 170 into an audio signal for output. To this end, the audio output module 252 may include at least one speaker.

The haptic output module 253 generates a tactile output. For example, the haptic output module 253 may vibrate the steering wheel, a safety belt, a seat 110FL, 110FR, 110RL, 110RR such that the user can recognize such output.

The processor 270 may control an overall operation of each unit of the user interface apparatus 200.

According to an embodiment, the user interface apparatus 200 may include a plurality of processors 270 or may not include any processor 270.

When the processor 270 is not included in the user interface apparatus 200, the user interface apparatus 200 may operate according to a control of a processor of another apparatus within the vehicle 100 or the controller 170.

Meanwhile, the user interface apparatus 200 may be called as a display apparatus for vehicle.

The user interface apparatus 200 may operate according to the control of the controller 170.

The object detecting apparatus 300 is an apparatus for detecting an object located at outside of the vehicle 100.

The object may be a variety of objects associated with driving (operation) of the vehicle 100.

Referring to FIGS. 5 and 6, an object O may include a traffic lane OB10, another vehicle OB11, a pedestrian OB12, a two-wheeled vehicle OB13, traffic signals OB14 and OB15, light, a road, a structure, a speed hump, a geographical feature, an animal and the like.

The lane OB01 may be a driving lane, a lane next to the driving lane or a lane on which another vehicle comes in an opposite direction to the vehicle 100. The lanes OB10 may be a concept including left and right lines forming a lane.

The another vehicle OB11 may be a vehicle which is moving around the vehicle 100. The another vehicle OB11 may be a vehicle located within a predetermined distance from the vehicle 100. For example, the another vehicle OB11 may be a vehicle which moves before or after the vehicle 100.

The pedestrian OB12 may be a person located near the vehicle 100. The pedestrian OB12 may be a person located within a predetermined distance from the vehicle 100. For example, the pedestrian OB12 may be a person located on a sidewalk or roadway.

The two-wheeled vehicle OB13 may refer to a vehicle (transportation facility) that is located near the vehicle 100 and moves using two wheels. The two-wheeled vehicle OB13 may be a vehicle that is located within a predetermined distance from the vehicle 100 and has two wheels. For example, the two-wheeled vehicle OB13 may be a motorcycle or a bicycle that is located on a sidewalk or roadway.

The traffic signals may include a traffic light OB15, a traffic sign OB14 and a pattern or text drawn on a road surface.

The light may be light emitted from a lamp provided on another vehicle. The light may be light generated from a streetlamp. The light may be solar light.

The road may include a road surface, a curve, an upward slope, a downward slope and the like.

The structure may be an object that is located near a road and fixed on the ground. For example, the structure may include a streetlamp, a roadside tree, a building, an electric pole, a traffic light, a bridge and the like.

The geographical feature may include a mountain, a hill and the like.

Meanwhile, objects may be classified into a moving object and a fixed object. For example, the moving object may be a concept including another vehicle and a pedestrian. The fixed object may be a concept including a traffic signal, a road and a structure.

The object detecting apparatus 300 may include a camera 310, a radar 320, a lidar 330, an ultrasonic sensor 340, an infrared sensor 350 and a processor 370.

According to an embodiment, the object detecting apparatus 300 may further include other components in addition to the components described, or may not include some of the components described.

The camera 310 may be located on an appropriate portion outside the vehicle to acquire an external image of the vehicle. The camera 310 may be a mono camera, a stereo camera 310a, an AVM (Around View Monitoring) camera 310b, or a 360-degree camera.

For example, the camera 310 may be disposed adjacent to a front windshield within the vehicle to acquire a front image of the vehicle. Or, the camera 310 may be disposed adjacent to a front bumper or a radiator grill.

For example, the camera 310 may be disposed adjacent to a rear glass within the vehicle to acquire a rear image of the vehicle. Or, the camera 310 may be disposed adjacent to a rear bumper, a trunk or a tail gate.

For example, the camera 310 may be disposed adjacent to at least one of side windows within the vehicle to acquire a side image of the vehicle. Or, the camera 310 may be disposed adjacent to a side mirror, a fender or a door.

The camera 310 may provide an acquired image to the processor 370.

The radar 320 may include electric wave transmitting and receiving portions. The radar 320 may be implemented as a pulse radar or a continuous wave radar according to a principle of emitting electric waves. The radar 320 may be implemented by a Frequency Modulated Continuous Wave (FMCW) scheme or a Frequency Shift Keying (FSK) scheme according to a signal waveform in a continuous wave radar scheme.

The radar 320 may detect an object in a time of flight (TOF) manner or a phase-shift manner through the medium of electromagnetic waves, and detect a position of the detected object, a distance from the detected object and a relative speed with the detected object.

The radar 320 may be disposed on an appropriate position outside the vehicle for detecting an object which is located at a front, rear or side of the vehicle.

The lidar 330 may include laser transmitting and receiving portions. The lidar 330 may be implemented in a time of flight (TOF) manner or a phase-shift manner.

The lidar 330 may be implemented as a drive type or a non-drive type.

For the drive type, the lidar 330 may be rotated by a motor and detect object near the vehicle 100.

For the non-drive type, the lidar 330 may detect, through light steering, objects which are located within a predetermined range based on the vehicle 100. The vehicle 100 may include a plurality of non-drive type lidars 330.

The lidar 330 may detect an object in a time of flight (TOF) manner or a phase-shift manner through the medium of laser light, and detect a position of the detected object, a distance from the detected object and a relative speed with the detected object.

The lidar 330 may be disposed on an appropriate position outside the vehicle for detecting an object located at the front, rear or side of the vehicle.

The ultrasonic sensor 340 may include ultrasonic wave transmitting and receiving portions. The ultrasonic sensor 340 may detect an object based on an ultrasonic wave, and detect a position of the detected object, a distance from the detected object and a relative speed with the detected object.

The ultrasonic sensor 340 may be disposed on an appropriate position outside the vehicle for detecting an object located at the front, rear or side of the vehicle.

The infrared sensor 350 may include infrared light transmitting and receiving portions. The infrared sensor 340 may detect an object based on infrared light, and detect a position of the detected object, a distance from the detected object and a relative speed with the detected object.

The infrared sensor 350 may be disposed on an appropriate position outside the vehicle for detecting an object located at the front, rear or side of the vehicle.

The processor 370 may control an overall operation of each unit of the object detecting apparatus 300.

The processor 370 may detect an object based on an acquired image, and track the object. The processor 370 may execute operations, such as a calculation of a distance from the object, a calculation of a relative speed with the object and the like, through an image processing algorithm.

The processor 370 may detect an object based on a reflected electromagnetic wave which an emitted electromagnetic wave is reflected from the object, and track the object. The processor 370 may execute operations, such as a calculation of a distance from the object, a calculation of a relative speed with the object and the like, based on the electromagnetic wave.

The processor 370 may detect an object based on a reflected laser beam which an emitted laser beam is reflected from the object, and track the object. The processor 370 may execute operations, such as a calculation of a distance from the object, a calculation of a relative speed with the object and the like, based on the laser beam.

The processor 370 may detect an object based on a reflected ultrasonic wave which an emitted ultrasonic wave is reflected from the object, and track the object. The processor 370 may execute operations, such as a calculation of a distance from the object, a calculation of a relative speed with the object and the like, based on the ultrasonic wave.

The processor 370 may detect an object based on reflected infrared light which emitted infrared light is reflected from the object, and track the object. The processor 370 may execute operations, such as a calculation of a distance from the object, a calculation of a relative speed with the object and the like, based on the infrared light.

According to an embodiment, the object detecting apparatus 300 may include a plurality of processors 370 or may not include any processor 370. For example, each of the camera 310, the radar 320, the lidar 330, the ultrasonic sensor 340 and the infrared sensor 350 may include the processor in an individual manner.

When the processor 370 is not included in the object detecting apparatus 300, the object detecting apparatus 300 may operate according to the control of a processor of an apparatus within the vehicle 100 or the controller 170.

The object detecting apparatus 300 may operate according to the control of the controller 170.

The communication apparatus 400 is an apparatus for performing communication with an external device. Here, the external device may be another vehicle, a mobile terminal or a server. The communication device 400 may be referred to as a “wireless communication unit”.

The communication apparatus 400 may perform the communication by including at least one of a transmitting antenna, a receiving antenna, and radio frequency (RF) circuit and RF device for implementing various communication protocols.

The communication apparatus 400 may include a short-range communication unit 410, a location information unit 420, a V2X communication unit 430, an optical communication unit 440, a broadcast transceiver 450 and a processor 470.

According to an embodiment, the communication apparatus 400 may further include other components in addition to the components described, or may not include some of the components described.

The short-range communication unit 410 is a unit for facilitating short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication unit 410 may construct short-range area networks to perform short-range communication between the vehicle 100 and at least one external device.

The location information unit 420 is a unit for acquiring position information. For example, the location information unit 420 may include a Global Positioning System (GPS) module or a Differential Global Positioning System (DGPS) module.

The V2X communication unit 430 is a unit for performing wireless communications with a server (vehicle to infrastructure; V2I), another vehicle (vehicle to vehicle; V2V), or a pedestrian (vehicle to pedestrian; V2P). The V2X communication unit 430 may include an RF circuit capable of implementing a communication protocol with an infrastructure (V2I), a communication protocol between vehicles (V2V) and a communication protocol with a pedestrian (V2P).

The optical communication unit 440 is a unit for performing communication with an external device through the medium of light. The optical communication unit 440 may include a light-emitting diode for converting an electric signal into an optical signal and sending the optical signal to the exterior, and a photodiode for converting the received optical signal into an electric signal.

According to an embodiment, the light-emitting diode may be integrated with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel may include a satellite channel, a terrestrial channel, or both. The broadcast signal may include a TV broadcast signal, a radio broadcast signal and a data broadcast signal.

The processor 470 may control an overall operation of each unit of the communication apparatus 400.

According to an embodiment, the communication apparatus 400 may include a plurality of processors 470 or may not include any processor 470.

When the processor 470 is not included in the communication apparatus 400, the communication apparatus 400 may operate according to the control of a processor of another device within the vehicle 100 or the controller 170.

Meanwhile, the communication apparatus 400 may implement a display apparatus for a vehicle together with the user interface apparatus 200. In this instance, the display apparatus for the vehicle may be referred to as a telematics apparatus or an Audio Video Navigation (AVN) apparatus.

The communication apparatus 400 may operate according to the control of the controller 170.

The driving control apparatus 500 is an apparatus for receiving a user input for driving.

In a manual mode, the vehicle 100 may be operated based on a signal provided by the driving control apparatus 500.

The driving control apparatus 500 may include a steering input device 510, an acceleration input device 530 and a brake input device 570.

The steering input device 510 may receive an input regarding a driving (ongoing) direction of the vehicle 100 from the user. The steering input device 510 is preferably configured in the form of a wheel allowing a steering input in a rotating manner. According to some embodiments, the steering input device may also be configured in a shape of a touch screen, a touchpad or a button.

The acceleration input device 530 may receive an input for accelerating the vehicle 100 from the user. The brake input device 570 may receive an input for braking the vehicle 100 from the user. Each of the acceleration input device 530 and the brake input device 570 is preferably configured in the form of a pedal. According to some embodiments, the acceleration input device or the brake input device may also be configured in a shape of a touch screen, a touch pad or a button.

The driving control apparatus 500 may operate according to the control of the controller 170.

The vehicle operating apparatus 600 is an apparatus for electrically controlling operations of various devices within the vehicle 100.

The vehicle operating apparatus 600 may include a power train operating unit 610, a chassis operating unit 620, a door/window operating unit 630, a safety apparatus operating unit 640, a lamp operating unit 650, and an air-conditioner operating unit 660.

According to some embodiments, the vehicle operating apparatus 600 may further include other components in addition to the components described, or may not include some of the components described.

Meanwhile, the vehicle operating apparatus 600 may include a processor. Each unit of the vehicle operating apparatus 600 may individually include a processor.

The power train operating unit 610 may control an operation of a power train device.

The power train operating unit 610 may include a power source operating portion 611 and a gearbox operating portion 612.

The power source operating portion 611 may perform a control for a power source of the vehicle 100.

For example, upon using a fossil fuel-based engine as the power source, the power source operating portion 611 may perform an electronic control for the engine. Accordingly, an output torque and the like of the engine can be controlled. The power source operating portion 611 may adjust the engine output torque according to the control of the controller 170.

For example, upon using an electric energy-based motor as the power source, the power source operating portion 611 may perform a control for the motor. The power source operating portion 611 may adjust a rotating speed, a torque and the like of the motor according to the control of the controller 170.

The gearbox operating portion 612 may perform a control for a gearbox.

The gearbox operating portion 612 may adjust a state of the gearbox. The gearbox operating portion 612 may change the state of the gearbox into drive (forward) (D), reverse (R), neutral (N) or parking (P).

Meanwhile, when an engine is the power source, the gearbox operating portion 612 may adjust a locked state of a gear in the drive (D) state.

The chassis operating unit 620 may control an operation of a chassis device.

The chassis operating unit 620 may include a steering operating portion 621, a brake operating portion 622 and a suspension operating portion 623.

The steering operating portion 621 may perform an electronic control for a steering apparatus within the vehicle 100. The steering operating portion 621 may change a driving direction of the vehicle.

The brake operating portion 622 may perform an electronic control for a brake apparatus within the vehicle 100. For example, the brake operating portion 622 may control an operation of brakes provided at wheels to reduce speed of the vehicle 100.

Meanwhile, the brake operating portion 622 may individually control each of a plurality of brakes. The brake operating portion 622 may differently control braking force applied to each of a plurality of wheels.

The suspension operating portion 623 may perform an electronic control for a suspension apparatus within the vehicle 100. For example, the suspension operating portion 623 may control the suspension apparatus to reduce vibration of the vehicle 100 when a bump is present on a road.

Meanwhile, the suspension operating portion 623 may individually control each of a plurality of suspensions.

The door/window operating unit 630 may perform an electronic control for a door apparatus or a window apparatus within the vehicle 100.

The door/window operating unit 630 may include a door operating portion 631 and a window operating portion 632.

The door operating portion 631 may perform the control for the door apparatus. The door operating portion 631 may control opening or closing of a plurality of doors of the vehicle 100. The door operating portion 631 may control opening or closing of a trunk or a tail gate. The door operating portion 631 may control opening or closing of a sunroof.

The window operating portion 632 may perform the electronic control for the window apparatus. The window operating portion 632 may control opening or closing of a plurality of windows of the vehicle 100.

The safety apparatus operating unit 640 may perform an electronic control for various safety apparatuses within the vehicle 100.

The safety apparatus operating unit 640 may include an airbag operating portion 641, a seatbelt operating portion 642 and a pedestrian protecting apparatus operating portion 643.

The airbag operating portion 641 may perform an electronic control for an airbag apparatus within the vehicle 100. For example, the airbag operating portion 641 may control the airbag to be deployed upon a detection of a risk.

The seatbelt operating portion 642 may perform an electronic control for a seatbelt apparatus within the vehicle 100. For example, the seatbelt operating portion 642 may control passengers to be motionlessly seated in seats 110FL, 110FR, 110RL, 110RR using seatbelts upon a detection of a risk.

The pedestrian protecting apparatus operating portion 643 may perform an electronic control for a hood lift and a pedestrian airbag. For example, the pedestrian protecting apparatus operating portion 643 may control the hood lift and the pedestrian airbag to be open up upon detecting pedestrian collision.

The lamp operating portion 650 may perform an electronic control for various lamp apparatuses within the vehicle 100.

The air-conditioner operating unit 660 may perform an electronic control for an air conditioner within the vehicle 100. For example, the air-conditioner operating unit 660 may control the air conditioner to supply cold air into the vehicle when internal temperature of the vehicle is high.

The vehicle operating apparatus 600 may include a processor. Each unit of the vehicle operating apparatus 600 may individually include a processor.

The vehicle operating apparatus 600 may operate according to the control of the controller 170.

The operation system 700 is a system that controls various driving modes of the vehicle 100. The operation system 700 may be operated in the autonomous driving mode.

The operation system 700 may include a driving system 710, a parking exit system 740 and a parking system 750.

According to embodiments, the operation system 700 may further include other components in addition to components to be described, or may not include some of the components to be described.

Meanwhile, the operation system 700 may include a processor. Each unit of the operation system 700 may individually include a processor.

Meanwhile, according to embodiments, the operation system may be a sub concept of the controller 170 when it is implemented in a software configuration.

Meanwhile, according to embodiment, the operation system 700 may be a concept including at least one of the user interface apparatus 200, the object detecting apparatus 300, the communication apparatus 400, the vehicle operating apparatus 600 and the controller 170.

The driving system 710 may perform driving of the vehicle 100.

The driving system 710 may receive navigation information from a navigation system 770, transmit a control signal to the vehicle operating apparatus 600, and perform driving of the vehicle 100.

The driving system 710 may receive object information from the object detecting apparatus 300, transmit a control signal to the vehicle operating apparatus 600 and perform driving of the vehicle 100.

The driving system 710 may receive a signal from an external device through the communication apparatus 400, transmit a control signal to the vehicle operating apparatus 600, and perform driving of the vehicle 100.

The parking exit system 740 may perform an exit of the vehicle 100 from a parking lot.

The parking exit system 740 may receive navigation information from the navigation system 770, transmit a control signal to the vehicle operating apparatus 600, and perform the exit of the vehicle 100 from the parking lot.

The parking exit system 740 may receive object information from the object detecting apparatus 300, transmit a control signal to the vehicle operating apparatus 600 and perform the exit of the vehicle 100 from the parking lot.

The parking exit system 740 may receive a signal from an external device through the communication apparatus 400, transmit a control signal to the vehicle operating apparatus 600, and perform the exit of the vehicle 100 from the parking lot.

The parking system 750 may perform parking of the vehicle 100.

The parking system 750 may receive navigation information from the navigation system 770, transmit a control signal to the vehicle operating apparatus 600, and park the vehicle 100.

The parking system 750 may receive object information from the object detecting apparatus 300, transmit a control signal to the vehicle operating apparatus 600 and park the vehicle 100.

The parking system 750 may receive a signal from an external device through the communication apparatus 400, transmit a control signal to the vehicle operating apparatus 600, and park the vehicle 100.

The navigation system 770 may provide navigation information. The navigation information may include at least one of map information, information regarding a set destination, path information according to the set destination, information regarding various objects on a path, lane information and current location information of the vehicle.

The navigation system 770 may include a memory and a processor. The memory may store the navigation information. The processor may control an operation of the navigation system 770.

According to embodiments, the navigation system 770 may update prestored information by receiving information from an external device through the communication apparatus 400.

According to embodiments, the navigation system 770 may be classified as a sub component of the user interface apparatus 200.

The sensing unit 120 may sense a status of the vehicle. The sensing unit 120 may include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 may acquire sensing signals with respect to vehicle-related information, such as a posture, a collision, an orientation, a position (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal and the like.

The sensing unit 120 may further include an accelerator sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The interface unit 130 may serve as a path allowing the vehicle 100 to interface with various types of external devices connected thereto. For example, the interface unit 130 may be provided with a port connectable with a mobile terminal, and connected to the mobile terminal through the port. In this instance, the interface unit 130 may exchange data with the mobile terminal.

Meanwhile, the interface unit 130 may serve as a path for supplying electric energy to the connected mobile terminal. When the mobile terminal is electrically connected to the interface unit 130, the interface unit 130 supplies electric energy supplied from a power supply unit 190 to the mobile terminal according to the control of the controller 170.

The memory 140 is electrically connected to the controller 170. The memory 140 may store basic data for units, control data for controlling operations of units and input/output data. The memory 140 may be various storage apparatuses such as a ROM, a RAM, an EPROM, a flash drive, a hard drive, and the like in terms of hardware. The memory 140 may store various data for overall operations of the vehicle 100, such as programs for processing or controlling the controller 170.

According to embodiments, the memory 140 may be integrated with the controller 170 or implemented as a sub component of the controller 170.

The controller 170 may control an overall operation of each unit of the vehicle 100. The controller 170 may be referred to as an Electronic Control Unit (ECU).

The power supply unit 190 may supply power required for an operation of each component according to the control of the controller 170. Specifically, the power supply unit 190 may receive power supplied from an internal battery of the vehicle, and the like.

At least one processor and the controller 170 included in the vehicle 100 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

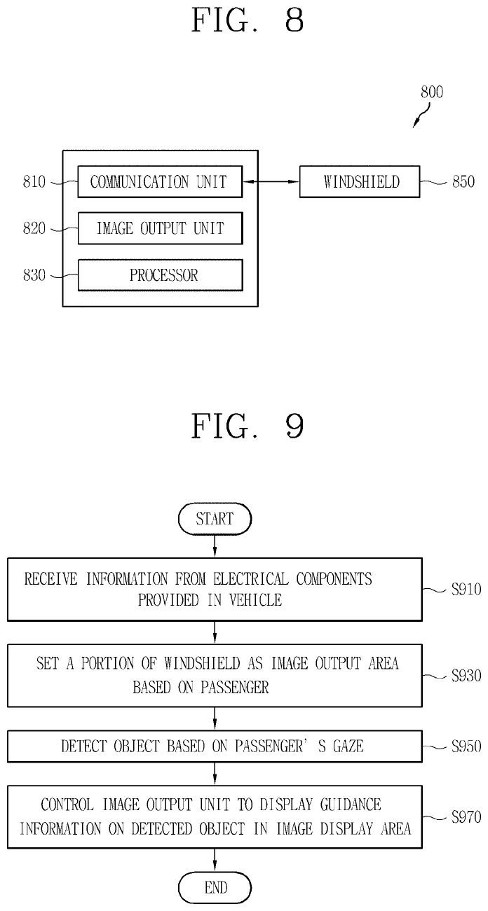

FIG. 8 is a conceptual view for explaining a vehicle control device according to an embodiment of the present disclosure.

Referring to FIG. 8, the vehicle control device 800 includes a communication unit 810, an image output unit 820, and a processor 830.

The communication unit 810 is configured to perform communication with the various components described in FIG. 7. For an example, the communication unit 810 may receive various information provided through a controller area network (CAN). In another example, the communication unit 810 may perform communication with all communicable devices, such as a vehicle, a mobile terminal and a server, and other vehicles. It may be referred to as V2X (vehicle to everything) communication. V2X communication may be defined as a technology that exchanges information such as traffic situation while communicating with road infrastructure and other vehicles while driving.

The communication unit 810 may receive information related to the driving of the vehicle from most of the devices provided in the vehicle 100. The information transmitted from the vehicle 100 to the vehicle control device 800 is referred to as “vehicle driving information.”

The vehicle driving information includes vehicle information and surrounding information of the vehicle. The information related to the inside of the vehicle with respect to the frame of the vehicle 100 may be defined as vehicle information, and the information related with the outside of the vehicle may be defined as surrounding information.

Vehicle information denotes information on the vehicle itself. For example, the vehicle information may include at least one of a driving speed of the vehicle, a driving direction, an acceleration, an angular speed, a position (GPS), a weight, a number of vehicle passengers, a braking force of the vehicle, a maximum braking force of the vehicle, an air pressure of each wheel, a centrifugal force applied to the vehicle, a driving mode of the vehicle (whether it is an autonomous driving mode or a manual driving mode), a parking mode of the vehicle (autonomous parking mode, automatic parking mode, manual parking mode), whether or not a user is on board the vehicle, information related to the user, and the like.

The surrounding information denotes information relate to another object located within a predetermined range around the vehicle and information related to the outside of the vehicle. The surrounding information of the vehicle may be a state of road surface (frictional force) on which the vehicle is traveling, weather, a distance from a front-side (rear-side) vehicle, a relative speed of a front-side (rear-side) vehicle, a curvature of curve when a driving lane is the curve, an ambient brightness of the vehicle, information associated with an object existing in a reference region (predetermined region) based on the vehicle, whether or not an object enters (or leaves) the predetermined region, whether or not a user exists around the vehicle, and information associated with the user (for example, whether or not the user is an authenticated user), and the like.

In addition, the surrounding information may include an ambient brightness, a temperature, a sun position, surrounding object information (a person, a vehicle, a sign, etc.), a type of road surface during driving, a geographic feature, line information, driving lane Information, and information required for autonomous driving/autonomous parking/automatic parking/manual parking mode.

Furthermore, the surrounding information may further include a distance from an object existing around the vehicle to the vehicle 100, a possibility of collision, a type of the object, a parking space for the vehicle, an object for identifying the parking space (for example, a parking line, a string, another vehicle, a wall, etc.), and the like.

The vehicle driving information is not limited to the example described above and may include all information generated from the components provided in the vehicle 100.

The image output unit 820 is configured to output various visual information to a windshield 850 of the vehicle 100. For example, various types of information such as text, still images, video, and holograms may be outputted to the windshield 850. A passenger may recognize images outputted from the image output unit 820 through the windshield 850, through which a user interface using augmented reality may be provided.

The windshield 850 is configured in such a way that transparency adjustment can be done in at least one area, and the transparency of a predetermined area where information outputted from the image output unit 820 is outputted may be set different than the transparency of other areas, so that the passenger can easily recognize this information.

The processor 830 is configured to control one or more displays provided in the vehicle 100 using the communication unit 810.

Specifically, the processor 830 may determine whether at least one of a plurality of preset conditions is satisfied based on vehicle driving information received through the communication unit 810. Depending on the satisfied conditions, the processor 830 may control the one or more displays in different ways.

In connection with the preset condition, the processor 830 may sense the occurrence of an event in an electronic unit and/or application provided in the vehicle 100 and determine whether the sensed event satisfies the preset condition. At this time, the processor 830 may detect the occurrence of an event from information received through the communication unit 810.

The application is a concept including a widget, a home launcher, and the like, and refers to all types of programs that can be driven on the vehicle 100. Accordingly, the application may be a program that performs a function of web browser, video playback, message transmission/reception, schedule management, and application update.

In addition, the application may include forward collision warning (FCW), blind spot detection (BSD), lane departure warning (LDW), pedestrian detection (PD), curve speed warning (CSW), and turn-by-turn navigation (TBT).

For example, an event may occur when there is a missed call, when there is an application to be updated, when a message arrives, start on, start off, autonomous driving on/off, LCD awake key, alarm, incoming call, missed notification, or the like.

For another example, an event may occur when a warning set by an advanced driver assistance system (ADAS) occurs or a function set by the ADAS is performed. For example, when a forward collision warning occurs, when a blind spot detection occurs, when a lane departure warning occurs, when a lane keeping assist warning occurs, when autonomous emergency braking function is performed, or the like may be seen as an occurrence of an event.

For another example, when changed from a forward gear to a reverse gear, when an acceleration greater than a predetermined value is generated, when a deceleration greater than a predetermined value is generated, when a power device is changed from an internal combustion engine to a motor, when changed from the motor to the internal combustion engine, or the like may also be seen as an occurrence of an event.

In addition, when various ECUs provided in the vehicle 100 perform a specific function may also be seen as an occurrence of an event.

When the occurred event satisfies a preset condition, the processor 830 controls the communication unit 810 to display information corresponding to the satisfied condition on the one or more displays.

On the other hand, the vehicle control device 800 may further include a sensor. The sensing unit may sense information related to the vehicle 100 of the present disclosure.

The information related to the vehicle may be at least one of vehicle information (or driving state of the vehicle) and surrounding information of the vehicle.

For example, the vehicle information may include a driving speed of the vehicle, a weight of the vehicle, a number of passengers in the vehicle, a braking force of the vehicle, a maximum braking force of the vehicle, a driving mode of the vehicle (autonomous driving mode or manual driving mode), a parking mode of the vehicle (autonomous parting mode, automatic parking mode, manual parking mode), whether or not a user gets on the vehicle, and information associated with the user (for example, whether or not the user is an authenticated user), and the like.

The surrounding information of the vehicle may be a state of road surface (frictional force) on which the vehicle is traveling, weather, a distance from a front-side (rear-side) vehicle, a relative speed of a front-side (rear-side) vehicle, a curvature of curve when a driving lane is the curve, an ambient brightness of the vehicle, information associated with an object existing in a reference region (predetermined region) based on the vehicle, whether or not an object enters (or leaves) the predetermined region, whether or not a user exists around the vehicle, and information associated with the user (for example, whether or not the user is an authenticated user), and the like.

Furthermore, the surrounding information (or surrounding environment information) of the vehicle may include external information of the vehicle (for example, ambient brightness, a temperature, a position of the sun, nearby subject (a person, another vehicle, a sign, etc.) information, a type of driving road surface, a landmark, line information, driving lane information), and information required for an autonomous driving/autonomous parking/automatic parking/manual parking mode.

Furthermore, the surrounding information of the vehicle may further include a distance from an object existing around the vehicle to the vehicle 100, a type of the object, a parking space for the vehicle, an object for identifying the parking space (for example, a parking line, a string, another vehicle, a wall, etc.), and the like.

The sensing unit may be a separate sensing unit which is distinct from the object detecting apparatus 300 or the sensing unit 120 equipped in the vehicle 100. The sensing unit, even though it is a separate sensing unit, may include features of the sensing unit 120 or object detecting apparatus 300 explained with reference to FIG. 7.

For ease of explanation, a description will be given below on an example in which the sensing unit is separately provided in the vehicle control device 800. If the processor 830 obtains certain information through the sensing unit, it can be understood that the processor 830 obtains certain information by using at least one between the object detecting apparatus 300 and the sensing unit 120 equipped in the vehicle 100.

The processor 830 may control at least one among the components explained with reference to FIG. 7 and the windshield 850.

The processor 830 included in the vehicle control device 800 related to the present invention may adjust the transparency of the windshield 850 if vehicle driving information satisfies a preset condition.

The vehicle control device 800 according to the present invention may control the windshield of the vehicle 100.

The windshield may be the above-explained window apparatus. The windshield is equipped in the vehicle, and a plurality of windshields may be provided.

The windshield explained in the present disclosure may include a front window disposed at the front, a rear window disposed at the rear, a sunroof window, etc., as well as a window device installed on a vehicle door.

The windshield related to the present invention may be formed in such a way as to allow for changing transparency. Here, the transparency may refer to light transmittance.

Higher transparency of the windshield may mean higher light transmittance. That is, an increase in light transmittance may mean that the amount of light that passes through the windshield increases. The higher the transparency of the windshield, the more transparent the windshield.

On the other hand, lower transparency of the windshield may mean lower light transmittance. That is, a decrease in light transmittance may mean that the amount of light that passes through the windshield decreases. The lower the transparency of the windshield, the more opaque the windshield.

The windshield related to the present invention may include a film that varies in transparency to adjust transparency. The film may include a PDLC (Polymer Dispersed liquid Crystal) film, an SPD (Suspended Particle Devices) film, an EC (Electrochromic) film, and so on.

If the windshield is configured as an image output apparatus for outputting text, images, etc., the processor 830 may control the windshield 850 to output various information through the windshield 850. In this case, the image output unit 820 may be omitted.

Hereinafter, various embodiments in which the vehicle control device related to the present invention controls the windshield of the vehicle will be described in more details with reference to the accompanying drawings.

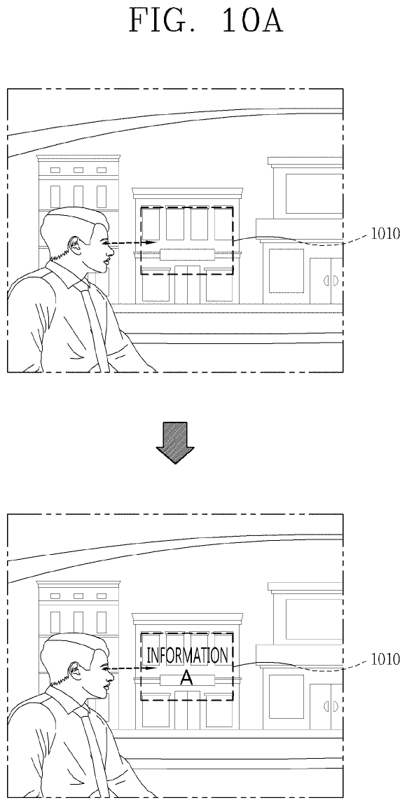

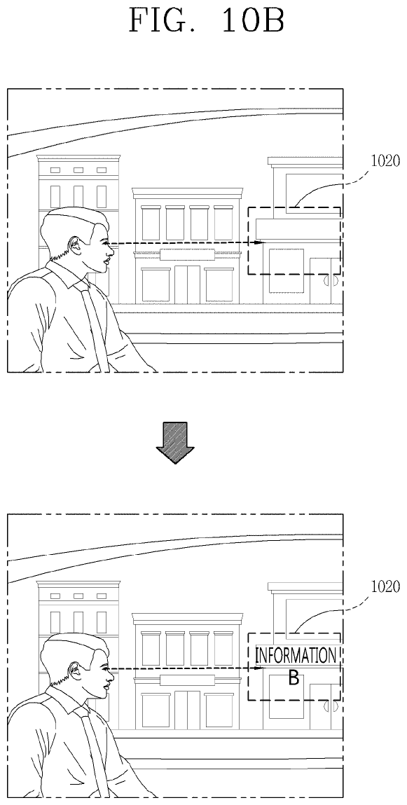

FIG. 9 is a flowchart for explaining a representative control method of the present disclosure. FIGS. 10A and 10B are illustrations of the control method of FIG. 9.

The processor 830 receives information from electrical components provided in the vehicle 100 through the communication unit 810 (S910).

The processor 830 may receive the vehicle driving information described above with reference to FIG. 9. Also, the processor 830 may receive sensing information created by a sensing unit provided in the vehicle control device 800.

For example, various information used as vehicle driving information may be transmitted to the processor 830 through the communication unit 810, including the amount of light coming in from outside the vehicle 100, the location of the sun, weather, a passenger's seat position, an object the passenger is looking at, and whether the passenger is closing their eyes or not.

Furthermore, the processor 830 may receive camera-captured images from an external camera for capturing the outside of the vehicle 100 and/or an internal camera for capturing the inside of the vehicle 100.

Next, the processor 830 may set a portion of a windshield as an image output area based on the passenger (S930).

The processor 830 may set the portion of the windshield as an “image output area”. The image output area is defined as an area where visual information is outputted through the image output unit 820.

The processor 830 may set the image output area based on the passenger's gaze. For example, if the gaze is directed in a first direction as shown in FIG. 10a, the image output area may be set in a first area 1010, and, if the gaze is directed in a second direction as shown in FIG. 10b, the image output area may be set in a second area 1020.

The processor 830 may set a center point based on the passenger's gaze, and may set an image output area of a predetermined size and shape with respect to the center point. The center point toward which the gaze is directed may be set the center point of the image output area.

Even when the passenger is looking at the same area, the processor 830 may set the image output area differently depending on the passenger, the passenger's seat position, the location of the vehicle 100, and/or the speed of the vehicle 100.

The image output area may vary with the passenger. For example, if the passenger sits in an assistant driver's seat of the vehicle 100, the image output area may be set on a windshield corresponding to the assistant driver's seat. Alternatively, the image output area may be set on a windshield corresponding to a backseat behind the assistant driver's seat.

At least one between the size and position of the image output area may vary with the passenger. This is because each passenger's arm is a different length. For example, when a child and an adult reach out their arms, their hands will touch different areas. Thus, the processor 830 may set the image output area differently for children and adults.

At least one between the size and position of the image output area may vary with the passenger's seat position. At least one between the size and position of an area the passenger can look at varies with the seat position. To provide an image output area best-suited to the passenger, the processor 830 may set the image output area differently depending on the passenger's seat position.

At least one between the size and position of the image output area may vary with the location of the vehicle. For example, if the vehicle is located on a highway or a countryside road, there will be a small number of objects of the passenger's interest. On the other hand, there will be a large number of objects of the passenger's interest in urban areas. To provide more accurate information, the image output area may be scaled down as the number of objects of the passenger's interest increases. In other words, if the vehicle 100 is located in a place that satisfies a first condition, the image output area may be set to a first size, whereas, if the vehicle 100 is located in a place that satisfies a second condition, the image output area may be set to a second size different from the first size.

At least one between the size and position of the image output area may vary with the speed of the vehicle. The higher the sped of the vehicle, the faster an object outside the vehicle passes by the passenger's gaze. To avoid missing the fast passing-by object, the image output area may become larger in size as the speed of the vehicle 100 becomes higher. In other words, if the vehicle 100 is traveling in a first speed range, the output image area may be set to a first size, whereas, if the vehicle 100 is traveling in a second speed range, the image output area may be set to a second size different from the first size.

The processor 830 detects an object based on the passenger's gaze (S950).

The processor 830 detects one or more objects overlapping the image output area based on the passenger's gaze, among objects located outside the vehicle.

The processor 830 may receive a camera-captured image from a camera equipped in the vehicle 100 through the communication unit 810. Also, the processor 830 may detect an object the passenger is looking at from the image. Among objects located outside the vehicle 100, one or more objects overlapping the image output area may be detected based on the passenger's gaze.

The basis for detecting an object may vary with each passenger. For example, if a first passenger is in the vehicle, the processor 830 may detect objects according to a first condition corresponding to the first passenger, and, if a second passenger is in the vehicle, the processor 830 may detect objects according to a second condition corresponding to the second passenger. This is because the types of objects of interest may vary with each passenger.

For example, let's say that a Korean and a Japanese are looking at the same building. The Korean will tend to look up a Korean restaurant among the restaurants in that building, and the Japanese will tend to look up a Japanese restaurant. The basis for detecting an object may be preset in a server or memory, and may be edited according to input from the passenger.

The processor 830 controls the image output unit to display guidance information on a detected object in the image display area (S970).

The guidance information may vary with the detected object.

For example, if the detected object is a store, the store's name, types of items they sell, phone number, reviews, etc. may be included in the guidance information. In another example, if the detected object is a vehicle, vehicle type, speed, whether platooning with this vehicle is possible or not, messages that can be transmitted to other vehicles, etc. may be included in the guidance information.

As shown in FIG. 10a, if Object A is detected by the passenger's gaze, Information A related to Object A is displayed in the first area 1010, and, as shown in FIG. 10b, if Object B is detected by the passenger's gaze, Information B related to Object B is displayed in the second area 1020.

The processor 830 may re-detect one or more objects as the vehicle 100 moves and update the guidance information to give guidance on the re-detected object(s). Since the vehicle 100 is moving, the object the passenger is looking at may be changed even if the passenger's gaze is directed in a constant direction. Therefore, the processor 830 continues to re-detect what object the passenger is looking at, based on the passenger's gaze, and update the guidance information so as to give guidance on a re-detected object.

The guidance information may include an image captured by a camera equipped in the vehicle 100. Specifically, the processor 830 may detect an object of the passenger's interest from the image, and control the image output unit 830 to display object-of-interest guidance information for giving guidance on the object of interest.

Since the passenger receives in real time guidance information related to an object they are looking at, they may obtain detailed information through augmented reality. This may increase user convenience.

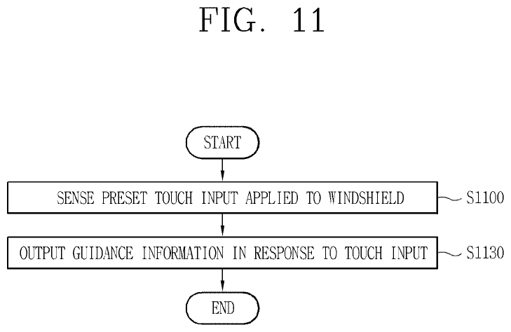

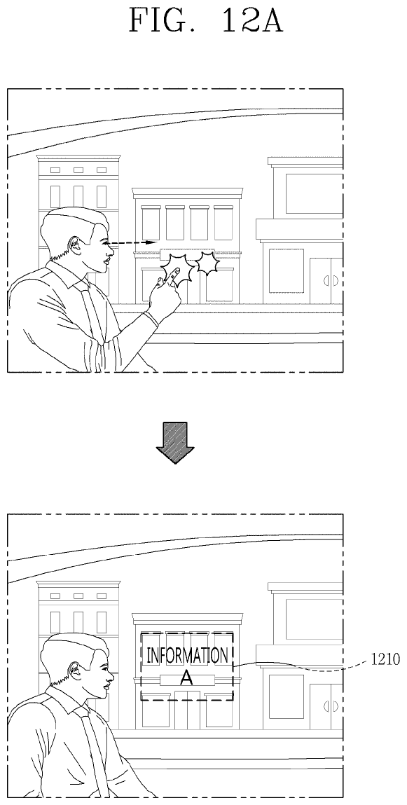

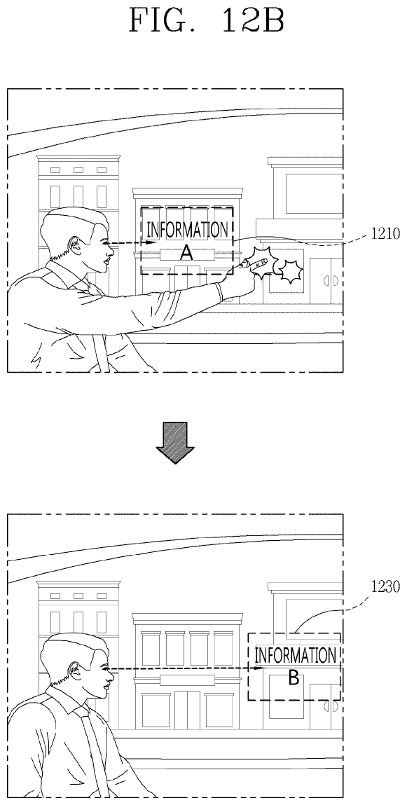

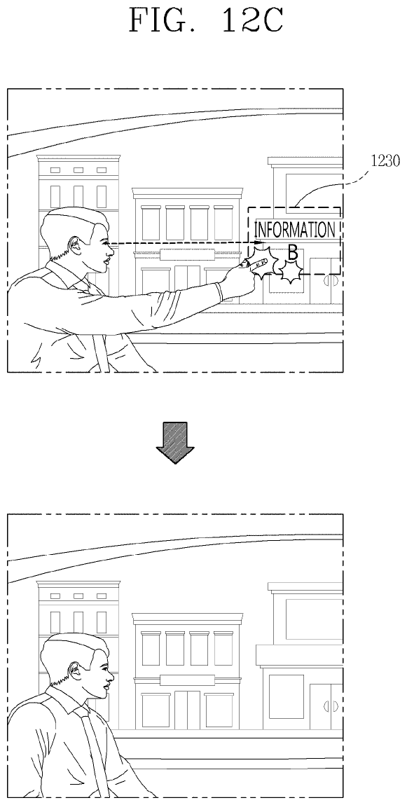

FIG. 11 is a flowchart for explaining a method of outputting guidance information via a preset touch input. FIGS. 12A, 12B, and 12C are illustrations of the method of FIG. 11.

The processor 830 may sense a preset touch input applied to the windshield 850 based on the vehicle driving information (S1100).

If guidance information on an object the passenger is looking at continues to be displayed in real time, the passenger may feel tired, because too much information is provided to the passenger.

A trigger may be set so that guidance information is outputted only at times when the passenger wants it. The trigger may be a preset touch input applied to the windshield. For example, as shown in FIG. 12A, the touch input may be a double-tap which is the act of tapping the windshield multiple times in a row. The preset touch input may be variously modified according to the embodiment.

The processor 830 may output the guidance information in response to the touch input (S1130).

The processor 830 may control the image output unit 820 to output guidance information 1210 in response to the touch input. The processor 830 may detect one or more objects overlapping the passenger's gaze and the position of the touch input, among objects located outside the vehicle. Also, guidance information corresponding to a detected object may be outputted through the image output unit 820. In other words, the guidance information is outputted only when the touch input is applied, but is not outputted unless the touch input is applied.

As shown in FIG. 12B, if the passenger's gaze is changed and a new touch input is applied, the guidance information 1210->1230 may be updated in response to the new touch input.

The processor 830 may set the image output area with respect to the position of the touch input. For example, the processor 830 may set a center point based on the position of the touch input, and an image output area of a predetermined size and predetermined shape may be set with respect to the center point. If the passenger's gaze is directed toward a first point and a touch input is applied to a second point, the processor 830 may set the image output area by considering the first point and the second point together.

The guidance information and the image output area may be altered by the touch input.

If the touch input is re-applied to the image output area while the guidance information is being outputted to the image output area, the processor 830 may control the image output unit 820 to make the guidance information disappear. For example, as shown in FIG. 12C, the processor 830 controls the image output unit 820 to make the guidance information 1230 disappear from the windshield 850, in response to the touch input applied to the image output area where the guidance information 1230 is outputted, while the guidance information 1230 is being outputted.

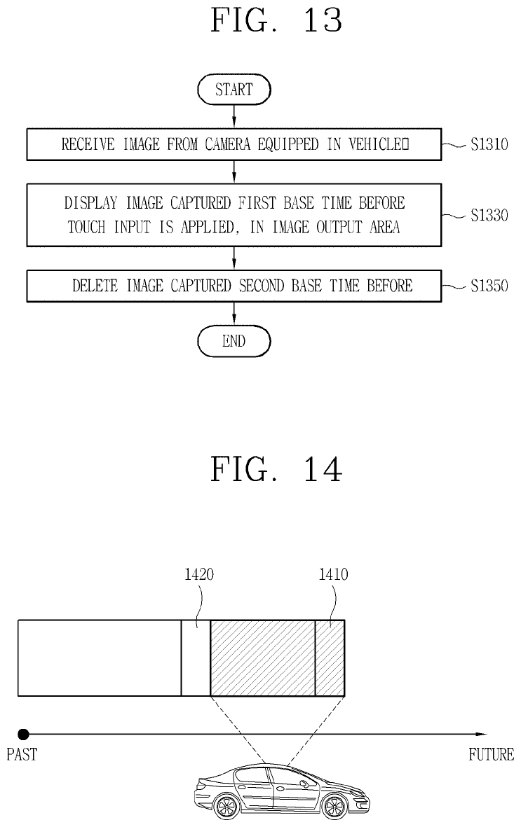

FIG. 13 is a flowchart for explaining a method of outputting guidance information by using a camera-captured image. FIG. 14 is a conceptual diagram for explaining the method of FIG. 13.

The processor 830 may receive an image from a camera equipped in the vehicle (S1310).

Images may be received from all cameras equipped in the vehicle. Alternatively, one or more cameras may be selected from among a plurality of cameras equipped in the vehicle based on the seat the passenger is sitting in, and images may be received from the selected camera(s). For example, if the passenger is sitting on the right side of the front part of the vehicle 100, a camera for capturing the left side of the vehicle 100 may be selected.

A camera-captured image consists of a plurality of frames. The processor 830 may receive the image through the communication unit 830, and may be stored in a memory (not shown). The frames are sequentially stored over time.

The processor 830 may display an image captured a first base time before the touch input is applied, in the image output area (S1330).

As shown in FIG. 14, frames may be aligned on a time axis, and the frames may be merged into a panoramic image. The current frame 1410 for the current time may be updated in real time. Also, among these frames, a past frame 1420 captured a predetermined time period (or the first base time) before the current time may be specified.

For example, if the first base time is set to 10 seconds, a frame captured 10 seconds before the current time may be selected, and the selected frame may be displayed as guidance information in the image output area.

The image being displayed in the image output area may be updated as the vehicle moves. For example, if it is now 23:20:10, a frame captured at 23:20:00 may be displayed in the image output area, whereas, if it is now 23:20:15, a frame captured at 23:20:05 may be displayed in the image output area. This is to let the passenger to view an image of the object they have just seen.

The first base time may vary with the speed of the vehicle 100. The first base time may be set to a first time period if the vehicle is traveling in a first speed range, and may be set to a second time period if the vehicle is traveling in a second speed range. For example, the first base time may be set to 10 seconds if the vehicle is traveling at 10 km, and may be set to 5 seconds if the vehicle is traveling at 100 km. This is because the moving distance varies with the speed of the vehicle.

The processor 830 may delete an image captured a second base time before (S1350).

If the frames continue to be stored in a memory, new frames cannot be stored due to lack of space in the memory. To solve this problem, the processor 830 may delete at least one between an image captured the second base time before the current time and an image stored in the memory the second base time before the current time. In this instance, the second base time is longer than the first base time.

For example, a frame captured 10 seconds (an example of the first base time) before the current time may be displayed as guidance information in the image output area, and a frame captured 20 seconds (an example of the second base time) before the current time may be deleted.

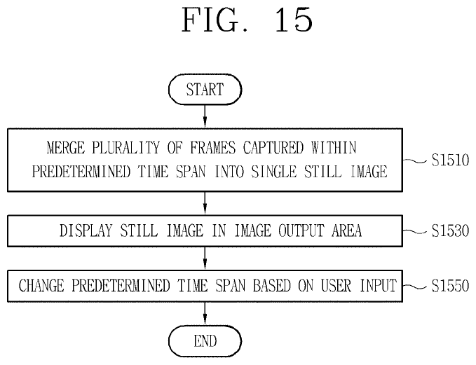

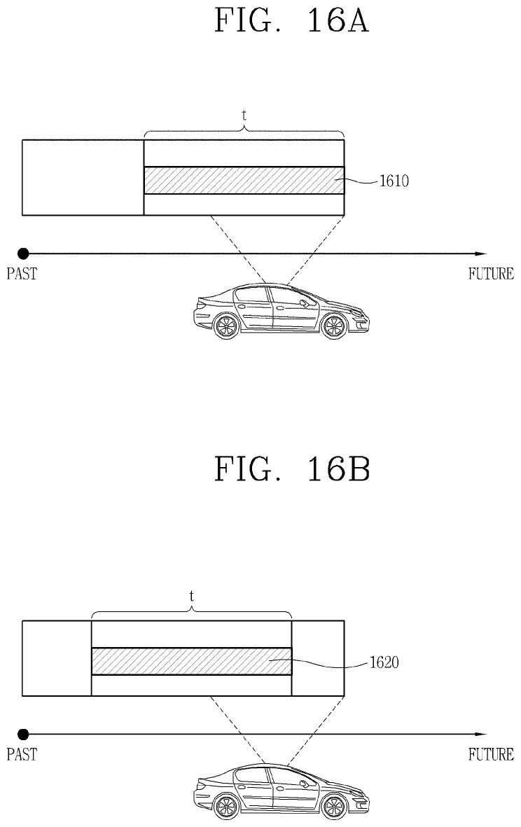

FIG. 15 is a flowchart for explaining a method of merging a plurality of frames to output guidance information. FIGS. 16A and 16B are conceptual diagrams for explaining the method of FIG. 15.

The processor 830 may merge a plurality of frames captured within a predetermined time span into a single still image (S1510).

For example, as shown in FIG. 16A, the predetermined time span (t) may be a period of time that spans the first base time until the time when the touch input is applied.

The predetermined time span may be variously changed according to the embodiment. Furthermore, as described with reference to FIG. 13, the predetermined time span may vary with the first base time.

The processor 830 may extract at least a portion of each frame corresponding to the image output area, and may merge extracted portions into a still image 1610. Some portion of each frame, not the entire area of each frame, may be extracted and merged into the still image 1610. The extracted portions correspond to the image output area and match the size of the image output area, thus allowing the passenger to see only some information they want.

The processor 830 may display the still image in the image output area (S1530).

The still image 1610 may be displayed as a background image of the image output area, and guidance information on an object detected by the processor 830 may be displayed on the still image 1610. As such, a user interface using virtual reality as well as augmented reality may be provided.

The processor 830 may change the predetermined time span based on user input (S1550).

Specifically, the processor 830 may change the time span based on a user input applied to the image output area where the still image is being outputted. The still image displayed in the image display area may be changed with the change in time span.

For example, if a drag input is applied to the image output area, the start time and/or end time of the predetermined time span may be changed depending on the drag direction. The still image 1610->1620 displayed in the image output area may be changed with the change in time span.

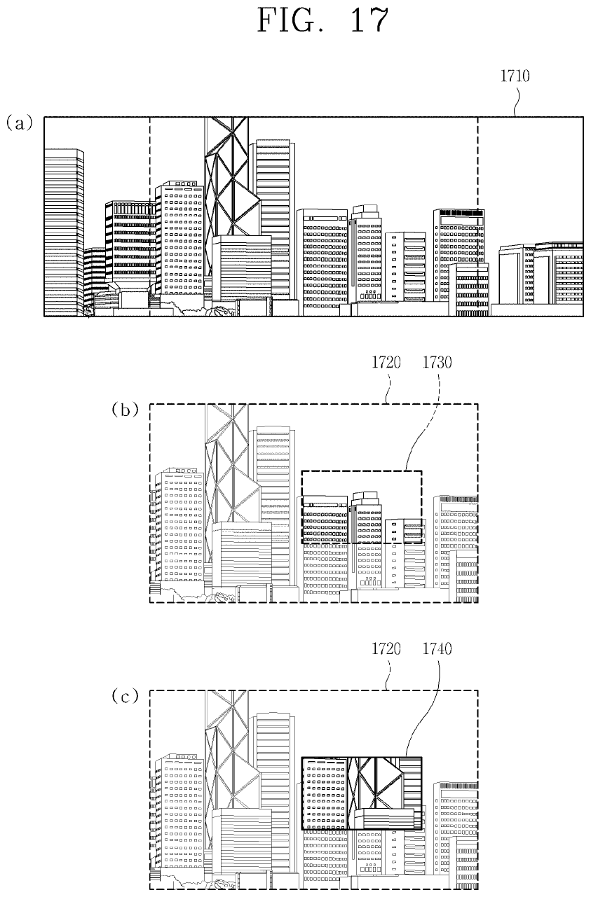

FIG. 17 is an illustration of an operation of a vehicle control device according to the present invention.

Referring to FIG. 17, a foreground view 1710 is depicted which the passenger is supposed to look at through a windshield while the vehicle is running. The passenger is able to visually recognize part 1720 of the foreground view 1710 from a particular point of view due to physical limitations of the windshield.

An image output area 1730 may be set by the passenger's gaze, and a past image 1740, which the passenger was looking at a predetermined period of time before through the image output area 1730, may be outputted through the image output area 1730.

As such, the passenger is able to view a past image of an object they have just seen, and the past image may contain guidance information related to the object. The passenger may get information about the object they have just seen even though the vehicle 100 is moving.

The foregoing present disclosure may be implemented as codes (an application or software) readable by a computer on a medium written by the program. The control method of the above-described autonomous vehicle may be implemented by codes stored in a memory or the like.

The computer-readable media may include all kinds of recording devices in which data readable by a computer system is stored. Examples of the computer-readable media may include ROM, RAM, CD-ROM, magnetic tape, floppy disk, and optical data storage device, and the like, and also include a device implemented in the form of a carrier wave (for example, transmission via the Internet). In addition, the computer may include a processor or controller. Accordingly, the detailed description thereof should not be construed as restrictive in all aspects but considered as illustrative. The scope of the invention should be determined by reasonable interpretation of the appended claims and all changes that come within the equivalent scope of the invention are included in the scope of the invention.

1. A vehicle control device for controlling a vehicle with a windshield, comprising:
an image output unit that outputs visual information to the windshield; and
a processor that sets a portion of the windshield as an image output area and controls the image output unit to display visual information in the image display area,
wherein the processor detects one or more objects overlapping the image output area based on the passenger's gaze, among objects located outside the vehicle, and controls the image output unit to display guidance information on a detected object in the image output area.

2. The vehicle control device of claim 1, wherein the processor outputs the guidance information in response to a preset touch input applied to the windshield.

3. The vehicle control device of claim 2, wherein the processor controls the image output unit to display an image captured a first base time before the touch input is applied, in the image output area.

4. The vehicle control device of claim 3, wherein the first base time varies with the speed of the vehicle.

5. The vehicle control device of claim 3, wherein the processor merges a plurality of frames captured within a predetermined time span into a single still image and controls the image output unit to display the still image in the image output area.

6. The vehicle control device of claim 5, wherein the processor extracts at least a portion of each frame corresponding to the image output area and merges extracted portions into the still image.

7. The vehicle control device of claim 5, wherein the processor changes the predetermined time span based on a user input applied to the image output area where the still image is being outputted, and the still image displayed in the image display area is changed with the change in time span.

8. The vehicle control device of claim 3, further comprising a communication unit that receives the image from a camera equipped in the vehicle.

9. The vehicle control device of claim 8, further comprising a memory that stores an image received from the camera,
wherein the processor deletes at least one between an image captured a second base time before and an image stored in the memory the second base time before, and the second base time is longer than the first base time.

10. The vehicle control device of claim 3, wherein the image is updated as the vehicle moves.

11. The vehicle control device of claim 3, wherein the processor detects an object of the passenger's interest from the image and controls the image output unit to display object-of-interest guidance information for giving guidance on the object of interest.

12. The vehicle control device of claim 11, wherein the object-of-interest guidance information varies with the passenger.

13. The vehicle control device of claim 2, wherein the processor sets the image output area with respect to the position of the touch input.

14. The vehicle control device of claim 2, wherein, if the touch input is re-applied to the image output area while the guidance information is being outputted to the image output area, the processor controls the image output unit to make the guidance information disappear.

15. The vehicle control device of claim 2, wherein the processor detects one or more objects overlapping the passenger's gaze and the position of the touch input, among objects located outside the vehicle.

16. The vehicle control device of claim 1, wherein the processor re-detects one or more objects as the vehicle moves and update the guidance information to give guidance on the re-detected object(s).

17. The vehicle control device of claim 1, wherein at least one between the size and position of the image output area varies with the passenger.

18. The vehicle control device of claim 1, wherein at least one between the size and position of the image output area varies with the location of the vehicle.

19. The vehicle control device of claim 1, wherein at least one between the size and position of the image output area varies with the passenger's seat position.

20. The vehicle control device of claim 1, wherein at least one between the size and position of the image output area varies with the speed of the vehicle.
